(19) United States
(12) Patent Application Publication
(10) Pub. No.: US 2026/0170851 A1
(43) Pub. Date: Jun. 18, 2026

(54) OUTSIDE-WORLD RECOGNITION DEVICE

(71) Applicant: Hitachi Astemo, Ltd., Hitachinaka-shi, Ibaraki (JP)

(72) Inventor: Kota IRIE, Hitachinaka-shi, Ibaraki (JP)

(73) Assignee: Hitachi Astemo, Ltd., Hitachinaka-shi, Ibaraki (JP)

(21) Appl. No.: 18/845,858

(22) PCT Filed: Jun. 28, 2022
(86) PCT No.: PCT/JP2022/025638

§ 371 Date: Sep. 10, 2024

(51) Int. Cl. G06V 20/58; G06V 10/56; G06V 10/60; G06V 10/62

(52) U.S. Cl. CPC G06V 20/584; G06V 10/56; G06V 10/60; G06V 10/62; G06V 2201/08

(57) ABSTRACT

Provided is an outside-world recognition device capable of accurately determining whether a lamp of another vehicle is blinking based on an image from a camera mounted on a host vehicle.

The outside-world recognition device 10 includes an image acquisition unit 1 that acquires a captured image from a camera 21 mounted on a host vehicle, an other vehicle detection unit 2 that detects another vehicle 31 at least a part of which is included in the captured image; an estimation unit 3 that generates a three-dimensional detection frame 33 of the other vehicle and estimates an orientation 34 and a size of the other vehicle 31, a processing area setting unit 4 that sets a processing area 35 inside or around the three-dimensional detection frame 33 based on an orientation 34 and a size of the other vehicle 31, and a blinking determination unit 5 that determines whether a lamp of the other vehicle 31 is blinking based on a time-series change in luminance information in the processing area 35.

### TECHNICAL FIELD

The present invention relates to an outside-world recognition device, and more particularly to an outside-world recognition device that determines whether a lamp of another vehicle is blinking on the basis of an image from a camera mounted on a host vehicle.

### BACKGROUND ART

In the automatic driving Lv.3 or higher system of the automobile, it is necessary to travel so as not to disturb the travel of the emergency vehicle. In addition, it is necessary to travel safely and smoothly by recognizing intention display by a winker of another vehicle.

For Example, Ptl 1 Discloses a Technique for recognizing another vehicle. In FIG. 1, FIG. 5, and paragraph 0028 of PTL 1, it is described that “By surrounding the area of the other vehicle shown in the two-dimensional image with an object imitating a stereoscopic shape, a target area representing as if the other vehicle is recognized in the three-dimensional space is set.”.

Further, as a technique related to determination of an emergency vehicle, for example, there is PTL 2. The abstract of PTL 2 describes that “when images captured by CCD cameras 10a and 10b are processed by an image processor 20 to calculate distance distribution information, the distance distribution information is read into a controller 30 to detect a road shape and three-dimensional positions of a plurality of three-dimensional objects (vehicles, obstacles, etc.) and identify a following vehicle. Then, the size of the detected following vehicle is compared, and the vehicle type of the following vehicle is determined based on the comparison result and displayed on the display 9. Further, it is determined whether a specific rotating lamp is turned on for each vehicle type, and when the rotating lamp is turned on, it is determined as an emergency vehicle and displayed on the display 9.”.

Here, as a method of setting a detection frame of a rotating lamp, paragraph 0045 of PTL 2 describes that “For example, the detection frame of the rotating lamp for each vehicle type is set at the upper part of the vehicle body in the case of the large vehicle in FIG. 8(a), set at the upper part of the vehicle body in the case of the normal and small vehicles in FIG. 8(b), and set at the middle of the vehicle body in the case of the two-wheeled vehicle in FIG. 8(c).”.

### CITATION LIST

### Patent Literature

PTL 1: JP 2021-60661 A
PTL 2: JP 2002-319091 A

### SUMMARY OF INVENTION

### Technical Problem

However, PTL 1 does not describe determination of an emergency vehicle. Further, PTL 2 describes setting the position of the detection frame of the rotating lamp for determining an emergency vehicle for each vehicle type, but only considers the case of the following vehicle captured by the rear camera. Therefore, for example, in a case where another vehicle does not face the front of the camera as in a case where an image is captured by a camera other than the rear camera, there is a possibility that the position of the rotating lamp cannot be correctly recognized, and the position of the rotating lamp deviates from the detection frame of the rotating lamp, or the detection frame of the rotating lamp becomes too wide with respect to the position of the rotating lamp. As a result, there is a problem that lighting of the rotating lamp cannot be accurately detected.

An object of the present invention is to provide an outside-world recognition device capable of accurately determining whether a lamp of another vehicle is blinking based on an image from a camera mounted on a host vehicle.

### Solution to Problem

In order to solve the above problems, an outside-world recognition device of the present invention includes, for example, an image acquisition unit that acquires a captured image from a camera mounted on a host vehicle, an other vehicle detection unit that detects another vehicle at least a part of which is included in the captured image, an estimation unit that generates a three-dimensional detection frame of the other vehicle and estimates an orientation and a size of the other vehicle, a processing area setting unit that sets a processing area inside or around the three-dimensional detection frame based on the orientation and the size of the other vehicle, and a blinking determination unit that determines whether a lamp of the other vehicle is blinking based on a time-series change in luminance information in the processing area.

### Advantageous Effects of Invention

According to the outside-world recognition device of the present invention, since the processing area for determining whether the lamp of the other vehicle is blinking is set based on the orientation and size of the other vehicle, it is possible to accurately determine whether the lamp of the other vehicle is blinking based on the image from the camera mounted on the host vehicle.

### BRIEF DESCRIPTION OF DRAWINGS

FIG. 1 is a block diagram for explaining an outside-world recognition device of a first embodiment.

FIG. 2A is a diagram for explaining the operation of an other vehicle detection unit of the first embodiment.

FIG. 2B is a diagram for explaining the operation of an estimation unit according to the first embodiment.

FIG. 2C is a diagram for explaining the operation of a processing area setting unit of the first embodiment.

FIG. 3 is a diagram for explaining the operation of the processing area setting unit of the first embodiment.

FIG. 4A is a diagram for explaining the operation of a blinking determination unit according to the first embodiment.

FIG. 4B is a diagram for explaining the operation of the blinking determination unit of the first embodiment.

FIG. 5 is a diagram for explaining the operation of the outside-world recognition device according to a second embodiment.

FIG. 6 is a block diagram for explaining an outside-world recognition device of a third embodiment.

### DESCRIPTION OF EMBODIMENTS

Hereinafter, embodiments of the present invention will be described with reference to the drawings. In the drawings and the embodiments, the same or similar components are denoted by the same reference numerals, and redundant description is omitted.

### First Embodiment

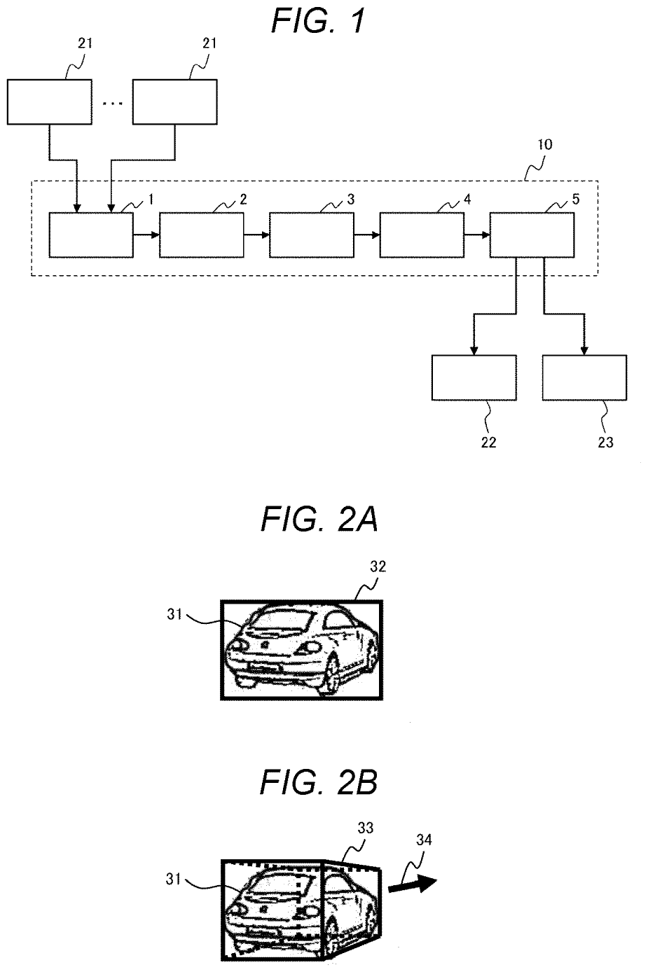

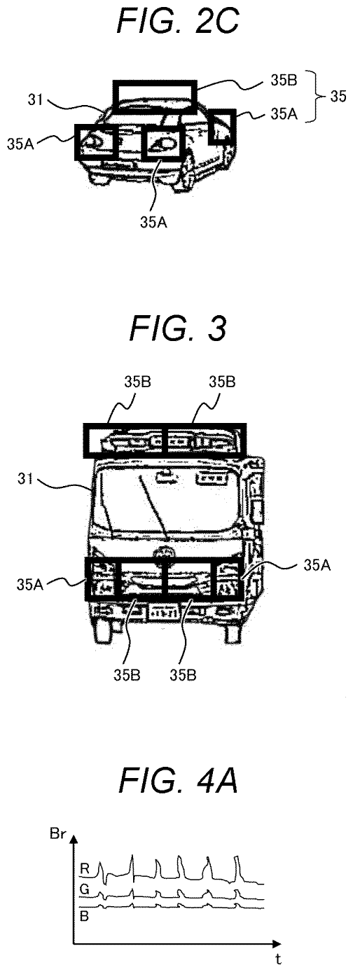

FIG. 1 is a block diagram for explaining an outside-world recognition device according to a first embodiment. FIG. 2A is a diagram for explaining the operation of an other vehicle detection unit of the first embodiment, FIG. 2B is a diagram for explaining the operation of an estimation unit of the first embodiment, and FIG. 2C is a diagram for explaining the operation of a processing area setting unit of the first embodiment.

In the host vehicle, for example, a camera 21, an outside-world recognition device 10, an alarm device 22, and a vehicle control device 23 are mounted. The number of cameras 21 may be plural or one. Each function of the outside-world recognition device 10, the alarm device 22, and the vehicle control device 23 can be implemented, for example, as a program executed by an electronic control unit (ECU) which is a computer for electronically controlling the host vehicle. The ECU includes, for example, an arithmetic device, a memory, a bus, an input unit, an output unit, a communication unit, and an external storage device.

The outside-world recognition device 10 of the first embodiment includes an image acquisition unit 1, an other vehicle detection unit 2, an estimation unit 3, a processing area setting unit 4, and a blinking determination unit 5.

The image acquisition unit 1 acquires a captured image from the camera 21 mounted on the host vehicle.

The other vehicle detection unit 2 detects another vehicle 31 at least partially included in the captured image. For example, as illustrated in FIG. 2A, an other vehicle detection frame 32 is generated so as to surround the other vehicle 31 in the captured image. The other vehicle detection unit 2 desirably has a function of tracking the detected other vehicle 31.

For example, as illustrated in FIG. 2B, the estimation unit 3 generates a three-dimensional detection frame 33 of the other vehicle 31, and estimates an orientation 34 and the size of the other vehicle 31. It is desirable that the estimation unit 3 also has a function of tracking the other vehicle 31.

The three-dimensional detection frame 33 is also called a 3D bounding box, and is a three-dimensional frame surrounding the other vehicle 31. As a method of generating the three-dimensional detection frame 33, there are various methods. For example, there are a monocular measurement method of causing artificial intelligence (AI) to learn vehicle patterns of various angles to generate the three-dimensional detection frame 33, a compound eye measurement method of recognizing a stereoscopic shape by stereoscopic vision to generate the three-dimensional detection frame 33, and a method of using another sensor such as causing light detection and ranging (LiDAR) to recognize a stereoscopic shape and fusion with camera image information to generate the three-dimensional detection frame 33.

The orientation 34 of the other vehicle 31 indicates a direction in front of the other vehicle 31, whereby the relative orientation with respect to the host vehicle can be recognized. The size of the other vehicle 31 may be the length of the three-dimensional detection frame in three directions (full width, full height, full length), or may be a standardized size such as a car rating.

The estimation unit 3 may also estimate a vehicle type of the other vehicle 31 in addition to the orientation 34 and the size of the other vehicle 31. Examples of the vehicle type include a two-wheeled vehicle, a light vehicle, a sedan, a SUV, a minivan, a bus, a truck, a towing trailer, and the like.

The processing area setting unit 4 sets a processing area 35 inside or around the three-dimensional detection frame 33 as illustrated in FIG. 2C based on the orientation 34 and the size of the other vehicle 31. The processing area setting unit 4 may set the processing area 35 on the basis of the vehicle type of the other vehicle 31 in addition to the orientation 34 and the size of the other vehicle 31.

The blinking determination unit 5 determines whether the lamp of the other vehicle 31 is blinking based on the time-series change in the luminance information in the processing area 35. Note that there is a case where blinking is used as a term similar to flickering, and both are strictly distinguished, but in the present specification, both are not distinguished. Therefore, the term of blinking in this specification is used as a term meaning a state in which light is repeatedly turned on and off.

According to the outside-world recognition device 10 of the first embodiment, the processing area 35, which is a detection frame for detecting blinking of the lamp, can be set at a position corresponding to the lamp of the other vehicle 31 in consideration of the orientation 34 of the other vehicle 31 using the three-dimensional detection frame 33. Therefore, even in a case where the other vehicle 31 is not facing the front of the camera 21, it is possible to correctly recognize the position of the lamp and set the processing area 35. This can prevent the position of the lamp from deviating from the processing area 35 or the processing area 35 from being too wide with respect to the position of the lamp. As described above, by correctly setting the processing area 35 at a position corresponding to the lamp, the S/N ratio at the time of measuring the time-series change in the luminance information is increased, and the blinking of the lamp can be easily recognized. Further, it is difficult to perform erroneous recognition due to a luminance change of the background. This makes it possible to accurately detect blinking of the lamp.

The blinking determination unit 5 can identify a type of the lamp based on at least one of a blinking cycle, a lighting color, an attachment position of the lamp, a size of the lamp, and a difference in blinking between right and left. Examples of the lamp include a winker and a hazard, and an emergency vehicle warning lamp indicating that an emergency vehicle is in emergency. The emergency vehicle warning lamp is, for example, a warning lamp using a red rotating lamp, but since the color varies depending on the country or region, it is desirable to vary the determination method depending on the country or region. Further, the present invention is not limited to the rotating lamp, and may be an LED or the like.

For example, a winker is characterized in that a blinking cycle is slow and there is a predetermined standard, a lighting color is orange (however, in the United States, it may be used also as a tail lamp), an attachment position of the lamp is at left and right ends of a vehicle body, a size of the lamp is small, and a difference in blinking between the left and right is either left or right blinking. The hazard is basically the same as the winker since the hazard is also used as the winker, but the difference in blinking between the right and left is different from the winker, and the left and right blinks synchronously and simultaneously.

The emergency vehicle warning lamp is characterized in that a blinking cycle is fast, a lighting color is red (however, there are cases where blue color or a combination of blue and red color is used overseas), an attachment position of the lamp is on the vehicle body or near the front grille (however, in the case of a two-wheeled vehicle, there are variations for each emergency vehicle, such as one on the left and right in the middle of the vehicle body and one at the rear of the vehicle body), a size of the lamp is large, and the emergency vehicle warning lamp blinks in synchronization with the left and right even in a case where a difference in blinking between the left and right is separated. The emergency vehicle warning lamp may not be divided into right and left parts.

As a result, the blinking determination unit 5 can determine whether the winker of the other vehicle 31 is blinking, whether the hazard of the other vehicle 31 is blinking, and whether the other vehicle 31 is an emergency vehicle in emergency.

This determination result is transmitted to the alarm device 22 and the vehicle control device 23 illustrated in FIG. 1 and used for automatic driving. For example, in a case where the winker of the other vehicle 31 is blinking, the alarm device 22 notifies the driver as necessary, and the vehicle control device 23 recognizes the intention of the winker of the other vehicle 31, and performs automatic driving so as to safely and smoothly travel or stop. In a case where the hazard of the other vehicle 31 is blinking, the alarm device 22 warns the driver, and the vehicle control device 23 performs automatic driving so that the vehicle travels or stops safely and smoothly by the vehicle control device 23. Further, in a case where the other vehicle 31 is an emergency vehicle in emergency, the alarm device 22 warns the driver, and the vehicle control device 23 performs automatic driving so as not to disturb the travel of the emergency vehicle.

In addition, as illustrated in FIG. 2C, the processing area setting unit 4 desirably sets, as the processing area 35, a first processing area 35A at a position corresponding to a winker and a hazard, and sets a second processing area 35B at a position corresponding to an emergency vehicle warning lamp indicating that the emergency vehicle is in emergency. Then, the blinking determination unit 5 desirably makes a method of determining blinking different between the first processing area 35A and the second processing area 35B. As a result, false recognition is reduced, and recognition of the type of the lamp and blinking of the lamp can be determined more accurately.

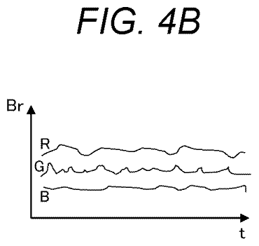

FIG. 3 is a diagram for explaining the operation of the processing area setting unit of the first embodiment. FIGS. 4A and 4B are diagrams for explaining the operation of the blinking determination unit of the first embodiment. In FIGS. 4A and 4B, the horizontal axis represents time t, and the vertical axis represents the luminance average value Br.

FIG. 3 illustrates an example in which the other vehicle 31 is a fire engine that is an emergency vehicle. The estimation unit 3 estimates that the size of the other vehicle 31 is large and the other vehicle is facing the front, and the processing area setting unit 4 sets each of the first processing area 35A and the second processing area 35B.

In a case where the emergency vehicle warning lamp in the second processing area 35B in the upper part of the vehicle body blinks in red, as illustrated in FIG. 4A, the R component indicating red among the RGB components of the luminance average value Br is large and greatly changes periodically. On the other hand, in a case where the emergency vehicle warning lamp is turned off, as illustrated in FIG. 4B, the R component is large, but the change is small, and is not periodic. Therefore, the blinking determination unit 5 can determine whether the other vehicle 31 is an emergency vehicle in emergency.

As described above, according to the outside-world recognition device 10 of the first embodiment, since the processing area 35 for determining whether the lamp of the other vehicle 31 is blinking is set on the basis of the orientation 34 and the size of the other vehicle 31, it is possible to accurately determine whether the lamp of the other vehicle 31 is blinking on the basis of the image from the camera 21 mounted on the host vehicle.

### Second Embodiment

A second embodiment is a modification of the first embodiment. The second embodiment is different from the first embodiment in that different cameras 21 cooperate with each other in a configuration of a multi-camera including a plurality of cameras 21. In the second embodiment, differences from the first embodiment will be mainly described, and other configurations and effects are the same as those of the first embodiment, and thus redundant description will be omitted.

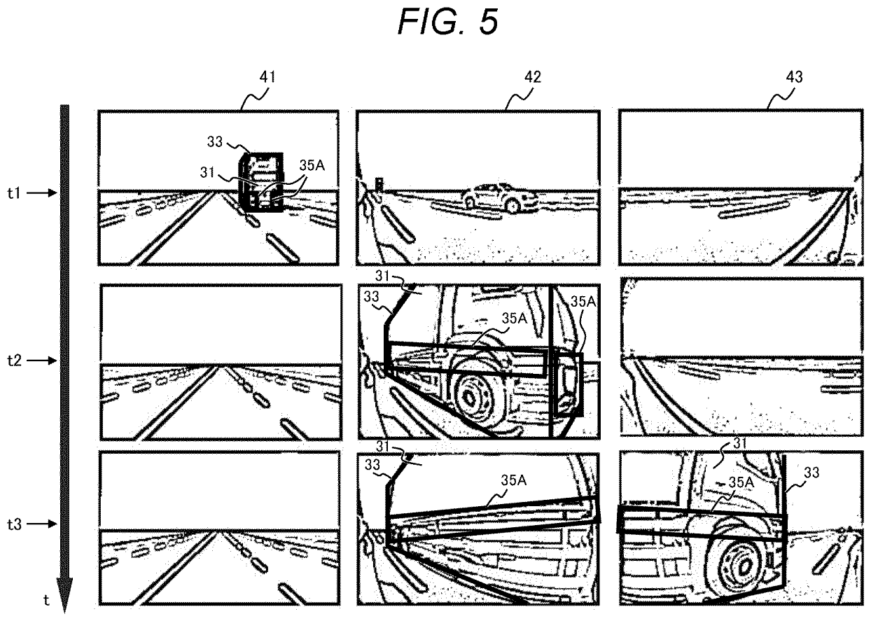

FIG. 5 is a diagram for explaining the operation of the outside-world recognition device according to the second embodiment. FIG. 5 illustrates a rear camera image 41, a rear left side camera image 42, and a front left side camera image 43 at times t1, t2, and t3. These images are acquired by the image acquisition unit 1 from the corresponding cameras 21.

At time t1, a truck is shown as the other vehicle 31 in the rear camera image 41. At this time, the other vehicle detection unit 2 detects the other vehicle 31, and the estimation unit 3 generates the three-dimensional detection frame 33 and estimates the orientation 34 and size of the other vehicle 31. The estimation unit 3 may further estimate a vehicle type of the other vehicle 31. The processing area setting unit 4 sets the first processing area 35A at a position corresponding to the winker as the processing area 35. Separately, the second processing area 35B is also set as the processing area 35, but is not illustrated in FIG. 5.

Thereafter, at time t2, the other vehicle 31 catches up with the host vehicle, and the other vehicle 31 appears only in the rear left side camera image 42. Since the side camera has a short distance to the other vehicle 31, the entire other vehicle 31 may not fit in the rear left side camera image 42. In this case, it may be difficult for the estimation unit 3 to generate the three-dimensional detection frame 33 or to estimate the orientation 34, the size, and the vehicle type of the other vehicle 31 only with the rear left side camera image 42.

Therefore, the estimation unit 3 of the second embodiment performs cooperation between the cameras 21 different tracking of the other vehicle 31, and generates the three-dimensional detection frame 33 of the other vehicle 31 in the rear left side camera image 42 at the time t2 which is a current time point on the basis of the size or the vehicle type of the other vehicle 31 estimated using the rear camera image 41 at the past time t1. That is, handover of the three-dimensional detection frame 33 is performed between different cameras 21. As a result, even in a case where the entire other vehicle 31 does not fit in the rear left side camera image 42, the three-dimensional detection frame 33 can be generated.

At this time, similarly to the estimation unit 3, the processing area setting unit 4 desirably cooperates with the cameras 21 different from the tracking of the other vehicle 31 to hand over the processing area 35.

The time has further elapsed, and at time t3, the other vehicle 31 appears across both the rear left side camera image 42 and the front left side camera image 43. Also at this time, similarly to the case of the time t2, it is desirable to cooperate between the rear left side camera image 42 and the front left side camera image 43 to hand over the three-dimensional detection frame 33 and the processing area 35.

In the above description, an example of cooperation from the rear camera to the side camera and an example of cooperation between the side cameras have been described, but the present invention is not limited thereto, and cooperation from the side camera to the front camera, cooperation from the front camera to the side camera, or cooperation from the side camera to the rear camera may be performed.

Therefore, the outside-world recognition device 10 according to the second embodiment can be configured such that, for example, the image acquisition unit 1 acquires a captured image from at least one of a front camera that captures at least an image of the front of the host vehicle or a rear camera that captures an image of the rear of the host vehicle and a side camera that captures an image of the side of the host vehicle, and the estimation unit 3 generates the three-dimensional detection frame 33 of the other vehicle 31 in the captured image of the second camera different from the first camera at the current time point on the basis of the size or the vehicle type of the other vehicle 31 estimated in the past using the captured image of the first camera.

Further, in the outside-world recognition device 10 of the second embodiment, for example, the processing area setting unit 4 can be configured to set the processing area 35 in the captured image of the second camera at the current time point on the basis of the processing area 35 set using the captured image of the first camera in the past.

According to the outside-world recognition device 10 of the second embodiment, even in a case where the other vehicle 31 does not fit in one captured image, the three-dimensional detection frame 33 and the processing area 35 can be succeeded by cooperation between the different cameras 21.

### Third Embodiment

A third embodiment is a modification of the first embodiment or the second embodiment. The third embodiment is different from the first or second embodiment in that a database capable of coping with a wide variety of emergency vehicles is provided. In the third embodiment, differences from the first or second embodiment will be mainly described, and other configurations and effects are the same as those of the first or second embodiment, and thus redundant description will be omitted.

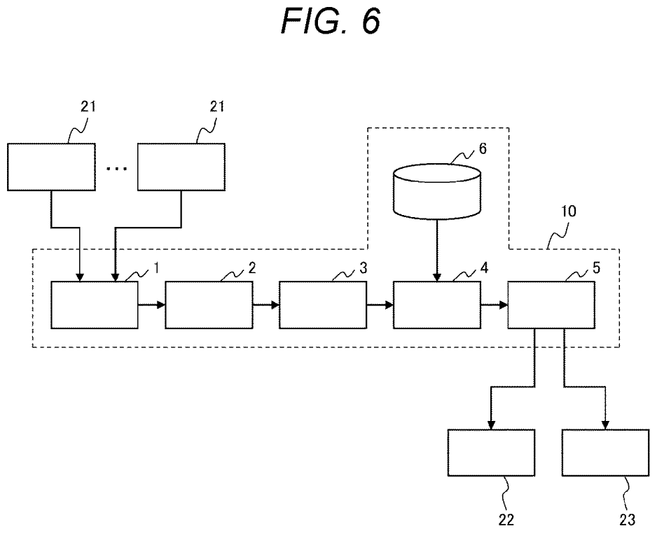

FIG. 6 is a block diagram for explaining an outside-world recognition device of the third embodiment.

The outside-world recognition device 10 of the third embodiment includes a database 6. Then, the processing area setting unit 4 sets the processing area 35 with reference to the database 6. This makes it possible to cope with a wide variety of emergency vehicles.

Here, if the database 6 can be updated by, for example, wireless communication or the like, it is possible to cope with a new emergency vehicle.

In addition, if the database 6 has a plurality of databases associated with the regions, and the processing area setting unit 4 sets the processing area 35 with reference to different databases according to the regions, it is possible to cope with a case where the position of the emergency vehicle warning lamp is different for each region.

Further, the blinking determination unit 5 may also be able to refer to the database 6. This makes it possible to switch the blinking determination method, for example, by changing the color of the emergency vehicle warning lamp according to the region.

Although the embodiments of the present invention have been described above, the present invention is not limited to the configurations described in the embodiments, and various modifications can be made within the scope of the technical idea of the present invention. In addition, some or all of the configurations described in the respective embodiments may be applied in combination.

### REFERENCE SIGNS LIST

1 image acquisition unit
2 other vehicle detection unit
3 estimation unit
4 processing area setting unit
5 blinking determination unit
6 database
10 outside-world recognition device
21 camera
22 alarm device
23 vehicle control device
31 other vehicle
32 other vehicle detection frame
33 three-dimensional detection frame
34 orientation
35 processing area
35A first processing area
35B second processing area
41 rear camera image
42 rear left side camera image
43 front left side camera image
Br luminance average value
t, t1, t2, t3 time

1. An outside-world recognition device comprising:
an image acquisition unit that acquires a captured image from a camera mounted on a host vehicle;
an other vehicle detection unit that detects another vehicle at least a part of which is included in the captured image;
an estimation unit that generates a three-dimensional detection frame of the other vehicle and estimates an orientation and a size of the other vehicle;
a processing area setting unit that sets a processing area inside or around the three-dimensional detection frame based on the orientation and the size of the other vehicle; and
a blinking determination unit that determines whether a lamp of the other vehicle is blinking based on a time-series change in luminance information in the processing area.

2. The outside-world recognition device according to claim 1, wherein
the estimation unit estimates a type of the other vehicle, and
the processing area setting unit sets the processing area based on the orientation, the size, and the type of the other vehicle.

3. The outside-world recognition device according to claim 1, wherein the blinking determination unit identifies a type of the lamp based on at least one of a blinking cycle, a lighting color, an attachment position of the lamp, a size of the lamp, and a difference in blinking between right and left.

4. The outside-world recognition device according to claim 1, wherein the processing area setting unit sets a first processing area at a position corresponding to a winker and a hazard, and sets a second processing area at a position corresponding to an emergency vehicle warning lamp indicating that an emergency vehicle is in emergency.

5. The outside-world recognition device according to claim 4, wherein the blinking determination unit makes a blinking determination method different between the first processing area and the second processing area.

6. The outside-world recognition device according to claim 1, wherein the blinking determination unit determines whether a winker of the other vehicle is blinking.

7. The outside-world recognition device according to claim 1, wherein the blinking determination unit determines whether a hazard of the other vehicle is blinking.

8. The outside-world recognition device according to claim 1, wherein the blinking determination unit determines whether the other vehicle is an emergency vehicle in emergency.

9. The outside-world recognition device according to claim 1, wherein
the image acquisition unit acquires the captured image from at least one of a front camera that captures at least an image of a front of the host vehicle and a rear camera that captures an image of a rear of the host vehicle, and a side camera that captures an image of a side of the host vehicle, and
the estimation unit generates the three-dimensional detection frame of the other vehicle in the captured image of a second camera different from a first camera at a current time point based on a size or a vehicle type of the other vehicle estimated using the captured image of the first camera in a past.

10. The outside-world recognition device according to claim 9, wherein the processing area setting unit sets the processing area in the captured image of the second camera at a current time point based on the processing area set using the captured image of the first camera in a past.

11. The outside-world recognition device according to claim 1, comprising an updatable database,
wherein the processing area setting unit sets the processing area with reference to the database.

12. The outside-world recognition device according to claim 1, comprising a plurality of databases associated with regions,
wherein the processing area setting unit sets the processing area with reference to different databases according to regions.
